(19) United States
(12) Patent Application Publication
(10) Pub. No.: US 2011/0273261 A1
(43) Pub. Date: Nov. 10, 2011

(54) Magnetically Shielded Inductor Structure

(76) Inventors: David M. Signoff, Mountain View, CA (US); Wayne A. Loeb, San Francisco, CA (US)

(21) Appl. No.: 13/099,622

(22) Filed: May 3, 2011

Related U.S. Application Data
(60) Provisional application No. 61/331,534, filed on May 5, 2010.

(51) Int. Cl. H01F 27/36

(52) U.S. Cl. 336/84 C

(57) ABSTRACT

In one embodiment, an apparatus includes an inductor and an electrically conductive structure surrounding the inductor. The electrically conductive structure conducts a current when a first magnetic field passes through the electrically conductive structure. The current creates a second magnetic field opposing the first magnetic field.

### CROSS REFERENCE TO RELATED APPLICATIONS

The present disclosure claims priority to U.S. Provisional App. No. 61/331,534 for “Magnetically Shielded Inductor Structure” filed May 5, 2010, which is incorporated herein by reference in its entirety for all purposes.

### BACKGROUND

Particular embodiments generally relate to a magnetically-shielded inductor structure.

Unless otherwise indicated herein, the approaches described in this section are not prior art to the claims in this application and are not admitted to be prior art by inclusion in this section.

In an integrated circuit (IC) chip, an inductor is a passive electrical component that stores energy in a magnetic field created by an electric current passing through it. Each inductor may include a number of coils where the loops create a magnetic field inside the coils. The magnetic field inside the coils may vary over time depending on the current passing through the inductor.

Multiple inductors on the chip may magnetically couple to each other. The inductors can couple to each other magnetically over significant on-chip distances, which is undesirable. One solution is to put as much distance as possible between inductors. However, as chip areas are decreasing, this becomes more difficult.

FIG. 1 depicts an example of two inductors 102a and 102b. Inductors 102a and 102b have areas 104a and 104b, respectively, that are considered keep-out areas. That is, components are not positioned in keep-out areas 104 on the chip. This may minimize the effect of magnetic coupling in the chip. However, the area in the chip may not be used efficiently. Also, with chip areas decreasing, using keep out areas 104 may be difficult.

### SUMMARY

In one embodiment, an apparatus includes an inductor and an electrically conductive structure surrounding the inductor. The electrically conductive structure conducts a current when a first magnetic field passes through the electrically conductive structure. The current creates a second magnetic field opposing the first magnetic field.

In one embodiment, the electrically conductive structure is located a distance from the inductor to achieve a desired Q (quality factor) for the inductor.

In one embodiment, the electrically conductive structure is located a distance from the inductor to achieve an inductance value for the inductor.

In one embodiment, the inductor includes a first inductor. The apparatus further includes a second inductor. An electric coupling between the first inductor and the second inductor is reduced by the second magnetic field.

In one embodiment, the electrically conductive structure includes a first electrically conductive structure and the inductor includes a first inductor. The apparatus includes a second inductor and a second electrically conductive structure surrounding the second inductor.

In one embodiment, a method includes passing a first magnetic field created by an inductor through an electrically conductive structure. The electrically conductive structure surrounds the inductor. A current is conducted around the electrically conductive structure when the first magnetic field passes through the electrically conductive structure. The current creates a second magnetic field opposing the first magnetic field.

The following detailed description and accompanying drawings provide a more detailed understanding of the nature and advantages of the present invention.

### BRIEF DESCRIPTION OF THE DRAWINGS

FIG. 1 depicts an example of two inductors.

FIG. 2a depicts an example of one electrically-conductive structure according to one embodiment.

FIG. 2b depicts an example including two electrically-conductive structures according to one embodiment.

FIG. 3 shows an example of connections to an electrically-conductive structure according to one embodiment.

FIG. 4 depicts a simplified flowchart of a method for providing shielding of inductor according to one embodiment.

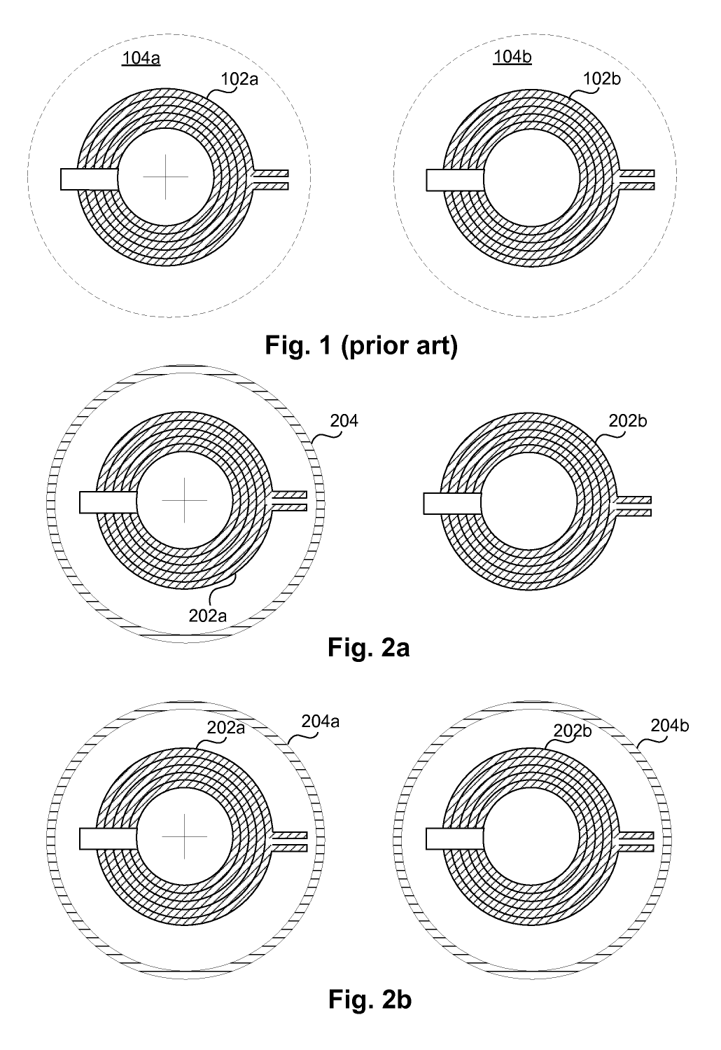

### DETAILED DESCRIPTION

Described herein are techniques for a magnetically-shielded inductor structure. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

Particular embodiments place an electrically-conductive structure around one or more inductors. The electrically-conductive structure reduces the coupling from one inductor to another inductor. The coupling may be reduced because a magnetic field passing through the electrically-conductive structure induces a current in the structure. That current creates an opposing magnetic field, which counteracts the effect of the magnetic field passing through the structure.

FIG. 2a depicts an example of one electrically-conductive structure according to one embodiment. FIG. 2b depicts an example including two electrically-conductive structures according to one embodiment. Inductors 202 may be included in an IC chip. When the term inductor 202 is used, the term may include a transformer. For example, although inductor 202a is shown, inductor 202a may be a transformer or part of a transformer.

Electrically-conductive structure 204 may surround the coils of inductor 202. If a transformer is being used, then the coils of both inductors of the transformer are surrounded by structure 204. Structure 204 may be a closed loop. In different examples, structure 204 may be a ring, a square, or other shapes that form a closed loop. A distance from a center point inside of the closed loop of structure 204 to an outer edge is greater than a distance from a center point inside of a coil of inductor 202 to an outer edge of the coil. For example, the radius or diameter of structure 204 may be greater than a respective radius or diameter of inductor 202.

In the layout of structure 204, a conductive line, such as a metal, may be used to form structure 204. In one example, inductor 202 may be formed on a first metal layer. Structure 204 may then be formed on another metal layer. However, the layers in which inductor 202 and structure 204 are formed on may vary. For example, different metal layer levels may be used or the same metal layer may be used. Also, structure 204 may be placed in an area previously considered to be a keep out area. The keep out area may be an area defined in the chip that surrounds inductor 202 in which components should not be placed, such as inductors 202. In one example, inductors 202a and 202b may be placed next to each other within an area that was conventionally defined as a keep out area. Thus, the distance between inductors 202a and 202b may be reduced using structure 204.

When a magnetic field passes through structure 204, a current is induced in the closed loop. For example, a time varying magnetic field passes through structure 204, which induces a current that flows around structure 204. The induced current in structure 204 creates an opposing magnetic field. The opposing magnetic field counteracts the effects of the magnetic field passing through structure 204. For example, the magnetic field passing through structure 204 is reduced.

Structure 204 may reduce the effects of a magnetic field that is passing through structure 204 in an inward or outward direction. For example, referring to FIG. 2a, a magnetic field from inductor 202a may pass outwardly through structure 204. An opposing magnetic field may be created by structure 204 to reduce the coupling of the outwardly passing magnetic field with inductor 202b. Also, a magnetic field from inductor 202b passes inwardly through structure 204. A current is induced that creates an opposing magnetic field in the outward direction. This reduces the effects of the inwardly passing magnetic field on inductor 202a.

In FIG. 2b, structures 204a and 204b are placed around inductors 202a and 202b, respectively. For inductor 202a or 202b, the effects described with respect to inductor 202a in FIG. 2a occur. One difference is a magnetic field from inductor 202a is reduced by structure 204a in the outward direction. Also, any effects of the reduced magnetic field are further reduced by structure 204b in that any magnetic field passing inwardly through structure 204b induces a current that creates an opposing magnetic field in the outward direction. This further counteracts any magnetic field that is produced by inductor 202a and reduces coupling between inductors 202a and 202b. Also, the magnetic field from inductor 202b passing through structure 204b is reduced by an opposing magnetic field from structure 204b. The same reduction also occurs at structure 204a.

Structure 204 may have an impact on the characteristics of inductor 202, such as a Q (quality factor) or an inductance of inductor 202. The inductance is an inductor's ability to store magnetic energy. The Q may measure the efficiency of inductor 202. For example, the Q may be a ratio of an inductor's inductive reactance to its resistance at a given frequency. The higher the Q of inductor 202 means the behavior of inductor 202 approaches the behavior of an ideal losses inductor.

Structure 204 may reduce the inductance of inductor 202. This is because the opposing magnetic field produced by structure 204 may reduce the inductor's ability to store magnetic energy.

Additionally, the Q of inductor 202 is reduced by placing structure 204 around inductor 202. The induced current in structure 204 consumes power that would otherwise be available to inductor 202a. Additionally, the opposing magnetic field reduces the magnetic field generated by inductor 202a, which reduces the Q of inductor 202a.

The impact on inductor 202 may be changed by adjusting the distance of structure 204 from inductor 202. The induced current and magnetic field may be proportional to the distance between inductor 202 and structure 204. For example, the farther away structure 204 is from inductor 202, the less induced current is produced and the opposing magnetic field is thus reduced. In one example, the diameter of a ring may be increased to reduce the effects on the inductance or Q. Also, if other shapes are used, the distance may be increased in a direction away from inductor 202.

The design of structure 204 may be changed based on the desired characteristics of inductor 202. For example, the distance from inductor 202 may be determined to achieve a desired Q value or a desired minimized coupling between inductors 202a and 202b. Also, it may be desirable to reduce the Q of inductor 202 in some designs. This may be achieved by placing structure 204 a certain distance from inductor 202 to reduce the Q by an amount. The reduced Q is achieved by using only the metal that is used to form structure 204.

Structure 204 may reduce gain step error. Gain steps are the gain in various stages of a path, such as a transmit path of a signal. Gain step error comes from multiple feedback loops from ground coupling and magnetic coupling. Structure 204 may reduce the feedback paths and reduce the gain step error by reducing coupling. Also, the gain may be reduced using structure 204. For example, a gain reduction of 4.7 dB is achieved by adding one structure 204. Adding both structures 204a and 204b may reduce the gain by 8.6 dB.

Also, structure 204 may be used to adjust when a transmitter oscillates. Without structure 204, a transmitter (using inductor 202) may oscillate at 20 deg Celsius and colder. With structure 204, the transmitter oscillates at −35 deg C. and colder.

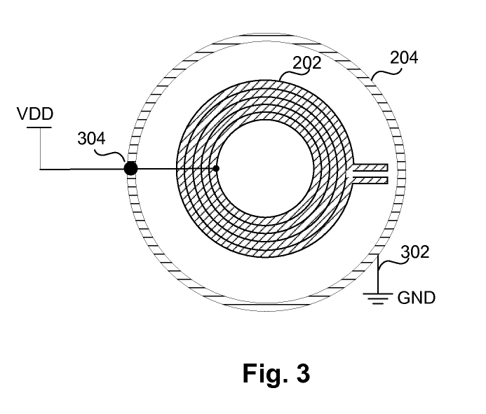

Structure 204 may be floating or can be connected to a node. FIG. 3 shows an example of connections to structure 204 according to one embodiment. At 302, a connection to ground (GND) is shown. Also, at 304, a connection to a power supply voltage (VDD) is shown. The connection to ground or the connection to the power supply voltage may be made, but, in one embodiment, both connections are not made in the same structure. Also, the connections at 302 and 304 may be removed so that structure 204 is floating.

If the connection from inductor 202 to VDD is on the same metal layer as structure 204, then a connection through structure 204 is allowed. This does not affect the opposing magnetic field generated by the current induced in structure 204.

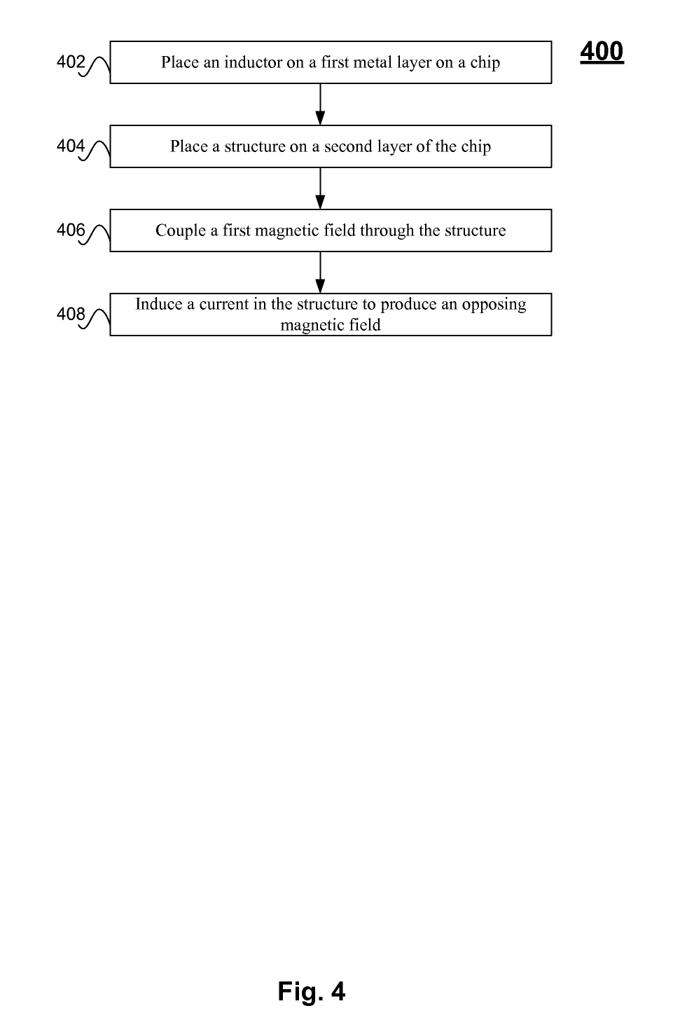

FIG. 4 depicts a simplified flowchart 400 of a method for providing shielding of inductor 202 according to one embodiment. At 402, an inductor is placed on a first metal layer on a chip. At 404, structure 204 is placed on the first metal layer or a second metal layer of the chip. Structure 204 surrounds inductor 202 in a closed loop. The placement of structure 204 may be based on desired characteristics of inductor 202.

At 406, a first magnetic field is coupled through structure 204. The magnetic field may be coupled inwardly or outwardly. At 408, a current is induced in structure 204. The current produces a second magnetic field to counteract the effects of the first magnetic field. The second magnetic field opposes the first magnetic field.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. An apparatus comprising:
an inductor; and
an electrically conductive structure surrounding the inductor, the electrically conductive structure configured to conduct a current when a first magnetic field passes through the electrically conductive structure,
wherein the current creates a second magnetic field opposing the first magnetic field.

2. The apparatus of claim 1, wherein the electrically conductive structure is located a distance from the inductor to achieve a desired Q (quality factor) for the inductor.

3. The apparatus of claim 2, wherein the Q of the inductor varies by an amount that depends on the distance from the inductor.

4. The apparatus of claim 1, wherein the electrically conductive structure is located a distance from the inductor to achieve an inductance value for the inductor.

5. The apparatus of claim 4, wherein the inductance of the inductor varies by an amount that depends on the distance from the inductor.

6. The apparatus of claim 1, wherein the first magnetic field passes in an outward direction and the second magnetic field is in an inward direction.

7. The apparatus of claim 1, wherein the first magnetic field passes in an inward direction and the second magnetic field is in an outward direction.

8. The apparatus of claim 1, wherein:
the inductor is on a first metal layer; and
the electrically conductive structure is on the first metal layer or a second metal layer.

9. The apparatus of claim 1, wherein the electrically conductive structure is a closed loop around the inductor.

10. The apparatus of claim 1, wherein the inductor comprises a first inductor, the apparatus further comprising a second inductor,
wherein an electric coupling between the first inductor and the second inductor is reduced by the second magnetic field.

11. The apparatus of claim 1, wherein the electrically conductive structure comprises a first electrically conductive structure and the inductor comprises a first inductor, the apparatus further comprising:
a second inductor; and
a second electrically conductive structure surrounding the second inductor.

12. The apparatus of claim 11, wherein the current comprises a first current, and wherein:
the second electrically conductive structure is configured to conduct a second current when the first magnetic field passes through the second electrically conductive structure, and
the second current creates a third magnetic field opposing the first magnetic field.

13. The apparatus of claim 11, wherein:
a first coupling of the first magnetic field from the first inductor to the second inductor is reduced by the first electrically conductive structure and the second electrically conductive structure, and
a second coupling of the second magnetic field from the second inductor to the first inductor is reduced by the first electrically conductive structure and the second electrically conductive structure.

14. The apparatus of claim 1, wherein the electrically conductive structure is floating, coupled to ground, or coupled to a supply voltage.

15. The apparatus of claim 1, wherein the inductor is part of a transformer.

16. A method comprising:
passing a first magnetic field created by an inductor through an electrically conductive structure, the electrically conductive structure surrounding the inductor;
conducting a current around the electrically conductive structure when the first magnetic field passes through the electrically conductive structure,
wherein the current creates a second magnetic field opposing the first magnetic field.

17. The method of claim 16, wherein the electrically conductive structure is located a distance from the inductor to achieve a desired Q (quality factor) for the inductor.

18. The method of claim 16, wherein the electrically conductive structure is located a distance from the inductor to achieve an inductance value for the inductor.

19. The method of claim 16, wherein the electrically conductive structure comprises a first electrically conductive structure, the method further comprising:
passing the first magnetic field through a second electrically conductive structure.

20. The method of claim 19, wherein the current comprises a first current, the method further comprising:
conducting a second current around the second electrically conductive structure when the first magnetic field passes through the second electrically conductive structure,
wherein the second current creates a third magnetic field opposing the first magnetic field.
